(19) United States
(12) Patent Application Publication
(10) Pub. No.: US 2026/0135660 A1
(43) Pub. Date: May 14, 2026

(54) DMRS DECODING CO-SCHEDULING ASSUMPTIONS

(71) Applicant: Telefonaktiebolaget LM Ericsson (publ), Stockholm (SE)

(72) Inventors: Per ERNSTRÖM, Stockholm (SE); Andreas NILSSON, Göteborg (SE); Siva MURUGANATHAN, Stittsville (CA); Jianwei ZHANG, Solna (SE)

(21) Appl. No.: 19/119,618

(22) PCT Filed: Oct. 11, 2023
(86) PCT No.: PCT/EP2023/078197

§ 371 Date: Apr. 9, 2025

Related U.S. Application Data
(60) Provisional application No. 63/415,834, filed on Oct. 13, 2022.

(51) Int. Cl. H04L 5/00

(52) U.S. Cl. CPC H04L 5/0051; H04L 5/0016

(57) ABSTRACT

A method, network node and wireless device (WD) for demodulation reference signal (DMRS) co-scheduling assumptions are disclosed. According to one aspect, a method in a WD includes receiving an indication of DMRS ports for which a sub-length orthogonality property of a frequency domain orthogonal cover code (FD-OCC) can be used to separate DMRS ports. The method also includes separating DMRS ports based on a co-scheduling assumption that other co-scheduled WDs are scheduled with DMRS ports that are sub-length orthogonal to the indicated DMRS ports.

### TECHNICAL FIELD

The present disclosure relates to wireless communications, and in particular, to demodulation reference signal (DMRS) co-scheduling assumptions.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### NR Frame Structure and Resource Grid

NR uses CP-OFDM (Cyclic Prefix Orthogonal Frequency Division Multiplexing) in both downlink (i.e., from a network node, gNB, or base station, to a user equipment or WD) and uplink (i.e., from WD to gNB). Discrete Fourier transform (DFT) spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically done on a slot basis (an example is shown in FIG. 1 with a 14-symbol slot) where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2μ) kHz where μ∈0, 1, 2, 3, 4. Δf=15 kHz is the basic subcarrier spacing. The slot durations at different subcarrier spacings is given by

$$\frac{1}{{2}^{μ}} m s .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink (DL) PDSCH transmissions may be either dynamically scheduled, i.e., in each slot the network node transmits downlink control information (DCI) over PDCCH (Physical Downlink Control Channel) indicating to which WD data is to be transmitted and on which RBs in the current downlink slot the data is transmitted, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, uplink (UL) PUSCH transmission may also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0_1, and DCI format 0_2.

### DMRS Configuration

Demodulation reference signals (DMRS) are used for coherent demodulation of physical layer data channels, i.e., Physical Downlink Shared Channel (PDSCH) and Physical Uplink Shared Channel (PUSCH), as well as of Physical Downlink Control Channel (PDCCH). The DMRS is confined to resource blocks carrying the associated physical layer channel and is mapped on allocated resource elements of the time-frequency resource grid such that the receiver may efficiently handle time/frequency-selective fading radio channels.

The mapping of DMRS to resource elements is configurable in both frequency and time domain. There are two mapping types in the frequency domain, i.e., type 1 and type 2. In addition, there are two mapping types in the time domain, i.e., mapping type A and type B, which defines the symbol position of the first OFDM symbol containing DMRS within a transmission interval.

The DMRS mapping in the time domain may further be single-symbol based or double-symbol based, where the latter means that DMRS is mapped in pairs of two adjacent OFDM symbols. For single symbol based DMRS, a WD may be configured with one, two, three, or four single-symbol DMRS (also referred to as additional DMRS) in a slot. For double-symbol based DMRS, a WD may be configured with one or two such double-symbol DMRS in a slot. In scenarios with low Doppler, it may be sufficient to configure front-loaded DMRS only, i.e., one single-symbol DMRS or one double-symbol DMRS, whereas in scenarios with high Doppler additional DMRS will be required in a slot.

FIG. 3 shows an example of type 1 and type 2 front-loaded DMRS with single-symbol and double-symbol DMRS and time domain mapping type A with first DMRS in the third OFDM symbol of a transmission interval of 14 symbols. It is observed from this figure that type 1 and type 2 differ with respect to both the mapping structure and the number of supported DMRS CDM groups where type 1 support 2 CDM groups and Type 2 support 3 CDM groups.

A DMRS antenna port is mapped to the resource elements within one CDM group only. For single-symbol DMRS, two antenna ports may be mapped to each CDM group whereas for double-symbol DMRS four antenna ports may be mapped to each CDM group. Hence, for DMRS type 1 the maximum number of DMRS ports is four for a single-symbol based DMRS configuration and eight for double-symbol based DMRS configuration. For DMRS type 2, the maximum number of DMRS ports is six for a single-symbol based DMRS configuration and twelve for double-symbol based DMRS configuration.

An orthogonal cover code (OCC) of length 2 (i.e., [+1, +1] or [+1, −1]) is used to separate antenna ports mapped in the same two resource elements within a CDM group. The OCC is applied in frequency domain (FD) as well as in time domain (TD) when double-symbol DMRS is configured. This is illustrated in FIG. 3 for CDM group 0.

In 3GPP NR Technical Release 15 (3GPP Rel-15), the mapping of a PDSCH DMRS sequence r(m), m=0, 1, . . . on antenna port p and subcarrier k in OFDM symbol l for the numerology index μ is specified in 3GPP NR Technical Specification (TS) 38.211 as:

$$\begin{matrix}{a}_{k , l}^{( p , μ )} = {β}_{PDSCH}^{D M R S} {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , …\end{matrix}$$

where w_{f}(k′) represents a frequency domain length 2 OCC code and wₜ(l′) represents a time domain length 2 OCC code. Table 1 and Table 2 show the PDSCH DMRS mapping parameters for configuration type 1 and type 2, respectively.

TABLE 1
PDSCH DMRS mapping parameters for configuration type 1

| | | |
|---|---|---|
| CDM | w_{f} (k′) | wₜ (l′) |

| p | group λ | Δ | k′ = 0 | k′ = 1 | l′ = O | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DMRS mapping parameters for configuration type 2

| | | |
|---|---|---|
| CDM | w_{f} (k′) | wₜ (l′) |

| p | group | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

For PDSCH mapping type A, DMRS mapping is relative to the slot boundary. That is, the first front-loaded DMRS symbol in DMRS mapping type A is in either the 3^{rd} or 4^{th} symbol of the slot. In addition to the front-loaded DMRS, type A DMRS mapping may include up to 3 additional DMRS. Some examples of DMRS for mapping type A are shown in FIG. 4 (note that a PDSCH length of 14 symbols is assumed in the examples).

FIG. 4 includes examples of DMRS configurations for PDSCH Mapping Type A. The figure assumes that the PDSCH duration is the full slot. If the scheduled PDSCH duration is shorter than the full slot, the positions of the DMRS changes according to the 3GPP TS 38.211 specification.

For PDSCH mapping type B, DMRS mapping is relative to transmission start. That is, the first DMRS symbol in DMRS mapping type B is in the first symbol in which type B PDSCH starts. Some examples of DMRS for mapping type A are shown in FIG. 5.

The same DMRS design for PDSCH is also applicable for PUSCH when transform precoding is not enabled, where the sequence r(m) shall be mapped to the intermediate quantity

$${ã}_{k , l}^{( {\tilde{p}}_{j} , μ )}$$

for DMRS port \tilde{p}ⱼ according to:

$$\begin{matrix}{\tilde{a}}_{k , l}^{( \tilde{p} , μ )} = {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , … \\ j = 0 , 1 , … , v - 1\end{matrix}$$

where w_{f}(k′), wₜ(l′), and Δ are given by Tables 6.4.1.1.3-1 and 6.4.1.1.3-2 in 3GPP TS 38.211, which are reproduced below, and v is the number of PUSCH transmission layers. The intermediate quantity

$${ã}_{k , l}^{( {\tilde{p}}_{j} , μ )} = 0$$

if Δ corresponds to any other antenna ports than \tilde{p}ⱼ.

The intermediate quantity

$${ã}_{k , l}^{( {\tilde{p}}_{j} , μ )}$$

shall be precoded, multiplied with the amplitude scaling factor

$${β}_{PUSCH}^{D M R S}$$

in order to conform to the transmit power specified in clause 6.2.2 of 3GPP TS 38.214, and mapped to physical resources according to

$$[ \begin{matrix}\begin{matrix}{a}_{k , l}^{{p}_{0} , μ} \\ ⋮\end{matrix} \\ {a}_{k , l}^{( {p}_{ρ ‐ 1} , μ )}\end{matrix} ] = {β}_{PUSCH}^{D M R S} W [ \begin{matrix}\begin{matrix}{\tilde{a}}_{k , l}^{{\tilde{p}}_{0} , μ} \\ ⋮\end{matrix} \\ {\tilde{a}}_{k , l}^{( {\tilde{p}}_{ρ ‐ 1} , μ )}\end{matrix} ]$$

where
the precoding matrix W is given by clause 6.3.1.5 of 3GPP TS 38.211 v17.3.0;
{p₀, . . . , p_{ρ-1}} is a set of physical antenna ports used for transmitting the PUSCH; and
{\tilde{p}₀, . . . , \tilde{p}_{υ-1}} is a set of DMRS ports for the PUSCH;

TABLE 6.4.1.1.3-1
Parameters for PUSCH DMRS configuration type 1.

| | | |
|---|---|---|
| CDM group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 6.4.1.1.3-2
Parameters for PUSCH DMRS configuration type 2.

| | | |
|---|---|---|
| CDM group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

The DMRS sequence r(n) for both PDSCH and PUSCH is defined by:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1 of 3GPP TS 38.211 V17.3.0. The pseudo-random sequence generator is initialized with:

$${c}_{i n i t} = ( {2}^{17} ( {N}_{s y m b}^{slot} {n}_{s , f}^{μ} + l + 1 ) ( 2 {N}_{ID}^{{\overline{n}}_{SCID}^{\overline{λ}}} + 1 ) + {2}^{17} ⌋ \frac{\overline{λ}}{2} ⌊ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame, and:
For PDSCH DMRS,

$${N}_{ID}^{0} , {N}_{I D}^{1}$$

∈{0, 1, . . . , 633555} are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI;
For PUSCH DMRS,

$${N}_{ID}^{0} , {N}_{I D}^{1}$$

∈{0, 1, . . . , 633555} are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant;
For PUSCH DMRS,

$${N}_{ID}^{0} , {N}_{I D}^{1}$$

∈{0, 1, . . . , 633555} are, for each msgA PUSCH configuration, given by the higher-layer parameters msgA-ScramblingID0 and msgA-ScramblingID1, respectively, in the msgA-DMRS-Config IE if provided and the PUSCH transmission is triggered by a Type-2 random access;
For PUSCH DMRS,

$${N}_{I D}^{0}$$

∈{0, 1, . . . , 633555} is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;
For PUSCH DMRS.

$${N}_{I D}^{0}$$

∈{0, 1, . . . , 633555} is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI;

$${N}_{I D}^{{\overline{n}}_{S C I D}^{\overline{λ}}} = {N}_{I D}^{cell}$$

otherwise;

$${\overline{n}}_{SCID}^{\overline{λ}}$$

and λ are given by:
   if the higher-layer parameter dmrs-Downlink in the DMRS-DownlinkConfig IE or dmrs-Uplink in the DMRS-UplinkConfig IE is provided, the corresponding

$${\overline{n}}_{SCID}^{\overline{λ}}$$

10 and λ̅ are determined as:

$${\overline{n}}_{S C I D}^{\overline{λ}} = \{ \begin{matrix}{n}_{S C I D} & λ = 0 or λ = 2 \\ 1 - {n}_{S C I D} & λ = 1\end{matrix}$$

$$\overline{λ} = λ$$

where λ is the CDM group index;
otherwise by

$${\overline{n}}_{S C I D}^{\overline{λ}} = {n}_{S C I D}$$

$$\overline{λ} = 0$$

The quantity n_{SCID}∈{0, 1} is given by the DMRS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a configured grant; otherwise n_{SCID}=0.

### DMRS Ports Signaling

DMRS port(s) for a PDSCH or a PUSCH are signaled in the corresponding scheduling DCI. In addition to the DMRS ports, the number of CDM groups that are not allocated for PDSCH or PUSCH and also the number of front-loaded DMRS symbols are dynamically signaled in the DCI.

“Antenna port” field in DCI 1_1 is defined as following in 3GPP TS 38.212 V17.3.0:
Antenna port(s)—4, 5, or 6 bits as defined by Tables 7.3.1.2.2-1/2/3/4 and Tables 7.3.1.2.2-1A/2A/3A/4A, where the number of CDM groups without data of values 1, 2, and 3 refers to CDM groups {0}, {0, 1}, and {0, 1, 2} respectively. The antenna ports {p₀, . . . , p_{υ-1}} shall be determined according to the ordering of DMRS port(s) given by Tables 7.3.1.2.2-1/2/3/4 or Tables 7.3.1.2.2-1A/2A/3A/4A. When a WD receives an activation command that maps at least one codepoint of DCI field ‘Transmission Configuration Indication’ to two TCI states, the WD shall use Table 7.3.1.2.2-1A/2A/3A/4A; otherwise, it shall use Tables 7.3.1.2.2-1/2/3/4. The WD may receive an entry with DMRS ports equals to 1000, 1002, 1003 when two TCI states are indicated in a codepoint of DCI field ‘Transmission Configuration Indication’.

If a WD is configured with both dmrs-DownlinkForPDSCH-MappingTypeA and dmrs-DownlinkForPDSCH-MappingType B, the bit width of this field equals max{x_{A}, x_{B}}, where x_{A} is the “Antenna ports” bit width derived according to dmrs-DownlinkForPDSCH-MappingTypeA and x_{B} is the “Antenna ports” bit width derived according to dmrs-DownlinkForPDSCH-MappingTypeB. A number of |x_{A}−x_{B}| zeros are padded in the MSB of this field, if the mapping type of the PDSCH corresponds to the smaller value of x_{A} and x_{B}.

“Antenna port” field in DCI 1_2 and DCI 0_2 is 0 bit if higher layer parameter, antennaPortsFieldPresentDCI-1-2 and antennaPortsFieldPresenceDCI-0-2 respectively, is not configured. The antenna port(s) are defined assuming bit field index value 0 in Tables 7.3.1.2.2-1/2/3/4 for DCI 1_2 and 7.3.1.1.2-6 to 7.3.1.1.2-23 for DCI 0_2.

In PUSCH scheduling, the number of layers are indicated separately from DMRS ports signaling in the DCI. For PDSCH scheduling, the number of layers and DMRS ports are signaled jointly in the DCI.

An “antenna port(s)” bit field in DCI is used for the purpose. An example for type 1 DMRS with rank=1 and up to two maximum number of front-loaded DMRS OFDM symbols for PUSCH is shown in Table 7.3.1.1.2-12 below, which is copied from 3GPP TS 38.212. Here 4 bits are used for the bit width of the ‘antenna port(s)’ field. Note that DMRS type and maximum number of front-loaded DMRS symbols are semi-statically configured by RRC.

TABLE 7.3.1.1.2-12
Antenna port(s), transform precoder is disabled,
dmrs-Type = 1, maxLength = 2, rank =
1 (from 3GPP TS 38.212 of 3GPP)

| | Number of DMRS CDM | | Number of front- |
|---|---|---|---|
| Value | group(s) without data | DMRS port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Another example for type 1 DMRS with up to two maximum number of front-loaded DMRS OFDM symbols for PDSCH is shown in Table 7.3.1.2.2-2 below, which is copied from 3GPP TS 38.212 V17.3.0.

TABLE 7.3.1.2.2-2
Antenna port(s) (1000 + DMRS port), dmrs-Type = 1,
maxLength = 2 (from 3GPP TS 38.212 V17.3.0)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

### DCI 1_0, DCI 0_0

DCI 1_0 is fallback DCI for downlink, DCI 0_0 is fallback DCI for uplink. It is specified in NR that DCI 1_0 applies only the Type 1 DMRS, because DCI 1_0 may be used to signal paging message and system information which are broadcasted for all WDs. While DCI 0_0 may apply either Type 1 or Type2, whichever is the configured DMRS type as in DMRS-Config under PUSCH-Config or configuredGrantConfig from WD specific signaling.

### SU-MIMO and Co-Scheduling of WD in the Downlink

For the antenna port tables defined for each DMRS types, some of the indices are specified to be used only for single user-multiple input multiple output (SU-MIMO). For remaining indices that may be used for multi-user (MU)-MIMO, the WD assumes the co-scheduled WD are scheduled with same DMRS-type and same number of DMRS symbols.

For DMRS configuration type 1:
if a WD is scheduled with one codeword and assigned with the antenna port mapping with indices of {2, 9, 10, 11 or 30} in Table 7.3.1.2.2-1 and Table 7.3.1.2.2-2 of Clause 7.3.1.2 of [5, 3GPP TS 38.212]; or
if a WD is scheduled with one codeword and assigned with the antenna port mapping with indices of {2, 9, 10, 11 or 12} in Table 7.3.1.2.2-1A and {2, 9, 10, 11, 30 or 31} in Table 7.3.1.2.2-2A of Clause 7.3.1.2 of [3GPP TS 38.212 V17.3.0]; or
if a WD is scheduled with two codewords; or
   the WD may assume that all the remaining orthogonal antenna ports are not associated with transmission of PDSCH to another WD.

For DMRS configuration type 2:
if a WD is scheduled with one codeword and assigned with the antenna port mapping with indices of {2, 10 or 23} in Table 7.3.1.2.2-3 and Table 7.3.1.2.2-4 of Clause 7.3.1.2 of [3GPP TS 38.212 V17.3.0]; or
if a WD is scheduled with one codeword and assigned with the antenna port mapping with indices of {2, 10, 23 or 24} in Table 7.3.1.2.2-3A and {2, 10, 23 or 58} in Table 7.3.1.2.2-4A of Clause 7.3.1.2 of [3GPP TS 38.212 V17.3.0]; or
if a WD is scheduled with two codewords the WD may assume that all the remaining orthogonal antenna ports are not associated with transmission of PDSCH to another WD.

In 3GPP NR Technical Release 18 (3GPP Rel-18) a larger number of DMRS ports is expected to be supported through the use of length 4 or length 6 FD-OCC (in NR Rel 15-17 only length 2 FD-OCC is supported). The larger length does, however, give a higher sensitivity to delay spread, resulting in worse channel estimation and throughput.

### SUMMARY

Some embodiments advantageously provide methods, network nodes, and wireless device for demodulation reference signal (DMRS) co-scheduling assumptions.

Methods to improve performance in terms of channel estimation and throughput through the use of sub-length-orthogonality properties of FD-OCC codes to separate DMRS ports are disclosed.

In some embodiments, the network node indicates to the wireless device (WD) when it may utilize the sub-length-orthogonality properties of FD-OCC codes used to separate DMRS ports. In some embodiments, the network node indicates which DMRS ports that are scheduled for other WDs for MU-MIMO. This may help the WD to perform proper interference cancellation for the upcoming MU-MIMO transmission.

Methods for DMRS decoding/channel estimation based on sub-length-orthogonality properties of FD-OCC codes used to separate DMRS ports are disclosed. In some embodiments, DCI indicates whether the WD may utilize the sub-length-orthogonality properties of FD-OCC codes used to separate DMRS ports, and potentially, the length of the sub-length orthogonality. Some embodiments provide improved downlink (DL) performance due to enhanced DMRS channel estimation quality and/or improved MU-MIMO interference cancellation.

According to one aspect, a wireless device (WD) configured to communicate with a network node is provided. The WD is configured to: receive an indication of demodulation reference signal, DMRS, ports for which a sub-length orthogonality property of a frequency domain orthogonal cover code, FD-OCC, can be used to separate DMRS ports; and separate DMRS ports based on a co-scheduling assumption that other co-scheduled WDs are scheduled with DMRS ports that are sub-length orthogonal to the indicated DMRS ports.

According to this aspect, in some embodiments, the WD is configured to assume that a first DMRS port uses a different code division multiplex, CDM, group than a DMRS port used by a co-scheduled WD indicated by the network node. In some embodiments, the WD is configured to receive an indication of additional co-scheduling assumptions can be used by the WD to separate the DMRS ports. In some embodiments, an additional co-scheduling assumption includes an assumption that all ports based at least in part on CDM groups corresponding to antenna ports indicated by the codepoint are used for co-scheduled WDs. In some embodiments, an additional co-scheduling assumption includes an assumption that all ports based at least in part on CDM groups corresponding to antenna ports indicated by the codepoint are length-2 FD-OCC orthogonal to ports indicated by the codepoint. In some embodiments, an additional co-scheduling assumption includes an assumption that all ports based at least in part on CDM groups corresponding to antenna ports indicated by the codepoint used for a co-scheduled WD are length-3 FD-OCC orthogonal to ports indicated by the codepoint. In some embodiments, the WD is configured to receive an indication of a first subset of DMRS ports belonging to a first code division multiplex, CDM, group and a subset of DMRS ports belonging to a second CDM group. In some embodiments, using the sub-length orthogonality property includes calculating channel estimates based at least in part on applying the FD-OCC over a sub-length of sub-carriers. In some embodiments, the WD is configured to use sub-length 2 FD-OCC orthogonality to separate the DMRS ports for channel estimation based at least in part on whether a single or double frontloaded DMRS has been configured. In some embodiments, the WD is configured to use sub-length 2 FD-OCC orthogonality to separate the DMRS ports for channel estimation based at least in part on whether a first FD-OCC vector and a first code division multiplex, CDM, group is used for a first DMRS port used for a first layer. In some embodiments, the WD is configured to use sub-length 2 FD-OCC orthogonality to separate the DMRS ports for channel estimation based at least in part on whether a second DMRS port for a second layer uses a second CDM group or uses a second FD-OCC vector that is sub-length 2 orthogonal to the first FD-OCC vector. In some embodiments, when a double frontload DMRS has been configured, the WD is configured to use sub-length 2 FD-OCC orthogonality to separate the DMRS ports based at least in part on whether a time division (TD)-OCC vector is used for the first DMRS port.

According to another aspect, a method in a wireless device (WD) configured to communicate with a network node is provided. The method includes: receiving an indication of demodulation reference signal, DMRS, ports for which a sub-length orthogonality property of a frequency domain orthogonal cover code, FD-OCC, can be used to separate DMRS ports; and separating DMRS ports based on a co-scheduling assumption that other co-scheduled WDs are scheduled with DMRS ports that are sub-length orthogonal to the indicated DMRS ports.

According to this aspect, in some embodiments, the method includes assuming that a first DMRS port uses a different code division multiplex, CDM, group than a DMRS port used by a co-scheduled WD indicated by the network node. In some embodiments, the method includes receiving an indication of additional co-scheduling assumptions can be used by the WD to separate the DMRS ports. In some embodiments, an additional co-scheduling assumption includes an assumption that all ports based at least in part on CDM groups corresponding to antenna ports indicated by the codepoint are used for co-scheduled WDs. In some embodiments, an additional co-scheduling assumption includes an assumption that all ports based at least in part on CDM groups corresponding to antenna ports indicated by the codepoint are length-2 FD-OCC orthogonal to ports indicated by the codepoint. In some embodiments, an additional co-scheduling assumption includes an assumption that all ports based at least in part on CDM groups corresponding to antenna ports indicated by the codepoint used for a co-scheduled WD are length-3 FD-OCC orthogonal to ports indicated by the codepoint. In some embodiments, the method incudes receiving an indication of a first subset of DMRS ports belonging to a first code division multiplex, CDM, group and a subset of DMRS ports belonging to a second CDM group. In some embodiments, using the sub-length orthogonality property includes calculating channel estimates based at least in part on applying the FD-OCC over a sub-length of sub-carriers. In some embodiments, the method includes using sub-length 2 FD-OCC orthogonality to separate the DMRS ports for channel estimation based at least in part on whether a single or double frontloaded DMRS has been configured. In some embodiments, the method includes using sub-length 2 FD-OCC orthogonality to separate the DMRS ports for channel estimation based at least in part on whether a first FD-OCC vector and a first code division multiplex, CDM, group is used for a first DMRS port used for a first layer. In some embodiments, the method includes using sub-length 2 FD-OCC orthogonality to separate the DMRS ports for channel estimation based at least in part on whether a second DMRS port for a second layer uses a second CDM group or uses a second FD-OCC vector that is sub-length 2 orthogonal to the first FD-OCC vector. In some embodiments, when a double frontload DMRS has been configured, the WD is configured to use sub-length 2 FD-OCC orthogonality to separate the DMRS ports based at least in part on whether a time division (TD)-OCC vector is used for the first DMRS port.

According to yet another aspect, a network node configured to communicate with a wireless device (WD) is provided. The network node is configured to: configure the with an indication of DMRS ports for which an orthogonality property of a frequency domain-orthogonal cover code, FD-OCC, can be used to separate the indicated DMRS ports; and configure the WD to separate DMRS ports based on a co-scheduling assumption that other co-scheduled WDs are scheduled with demodulation reference signal (DMRS) ports that are sub-length orthogonal to the indicated DMRS ports.

According to this aspect, in some embodiments, the indication indicates a length of sub-length orthogonality. In some embodiments, the indication indicates a set of at least one codepoint indicating DMRS ports to be separated using sub-length orthogonal FD-OCC. In some embodiments, the indication indicates when the WD is to assume that a DMRS port used for co-scheduling is sub-length orthogonal to DMRS ports used by the WD. In some embodiments, the indication indicates when the WD is to assume that a DMRS port used for co-scheduling uses one of a different code division multiplex, CDM, group and a different time domain orthogonal cover code (TD-OCC) vector than a port and CDM group used by the WD. In some embodiments, the indication indicates when the WD is to assume that a DMRS port used for co-scheduling is sub-length orthogonal to at least one port indicated by a codepoint. In some embodiments, the network node is configured to transmit an indication of at least one other co-scheduled WD.

According to another aspect, a method in a network node configured to communicate with a wireless device (WD) is provided. The method includes: configuring the WD with an indication of DMRS ports for which an orthogonality property of a frequency domain-orthogonal cover code, FD-OCC, can be used to separate the indicated DMRS ports; and configuring the WD to separate DMRS ports based on a co-scheduling assumption that other co-scheduled WDs are scheduled with demodulation reference signal (DMRS) ports that are sub-length orthogonal to the indicated DMRS ports.

According to this aspect, in some embodiments, the indication indicates a length of sub-length orthogonality. In some embodiments, the indication indicates a set of at least one codepoint indicating DMRS ports to be separated using sub-length orthogonal FD-OCC. In some embodiments, the indication indicates when the WD is to assume that a DMRS port used for co-scheduling is sub-length orthogonal to DMRS ports used by the WD. In some embodiments, the indication indicates when the WD is to assume that a DMRS port used for co-scheduling uses one of a different code division multiplex, CDM, group and a different time domain orthogonal cover code (TD-OCC) vector than a port and CDM group used by the WD. In some embodiments, the indication indicates when the WD is to assume that a DMRS port used for co-scheduling is sub-length orthogonal to at least one port indicated by a codepoint. In some embodiments, the method includes transmitting an indication of at least one other co-scheduled WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of a 14-symbol slot;

FIG. 2 is an example of a NR physical resource grid;

FIG. 3 Front-loaded DMRS for configuration type 1 and type 2;

FIG. 4 shows examples of DMRS configurations for PDSCH Mapping Type A;

FIG. 5 shows examples of DMRS configurations for PDSCH Mapping Type B;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node for demodulation reference signal (DMRS) co-scheduling assumptions;

FIG. 13 is a flowchart of an example process in a wireless device for demodulation reference signal (DMRS) co-scheduling assumptions;

FIG. 14 is a flowchart of another example process in a network node for demodulation reference signal (DMRS) co-scheduling assumptions; and

FIG. 15 is a flowchart of another example process in a wireless device for demodulation reference signal (DMRS) co-scheduling assumptions.

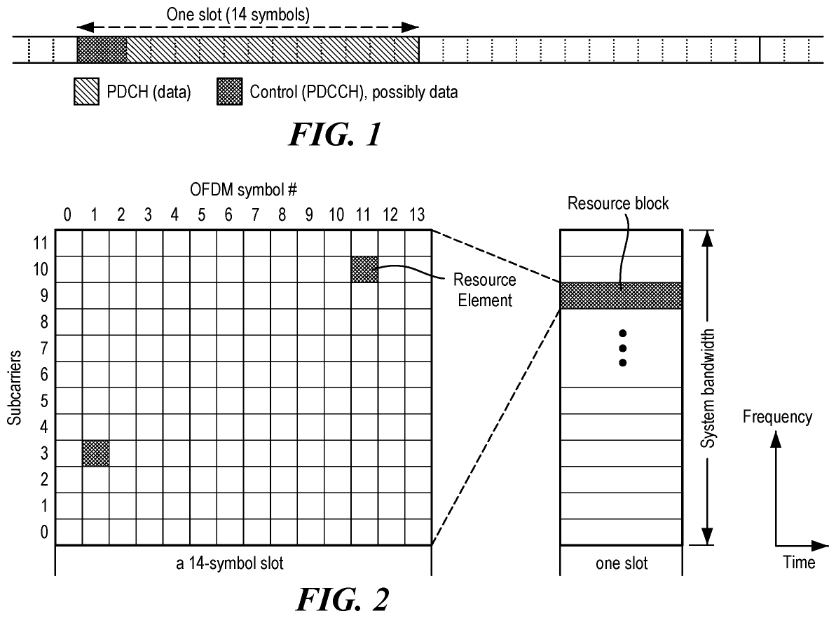

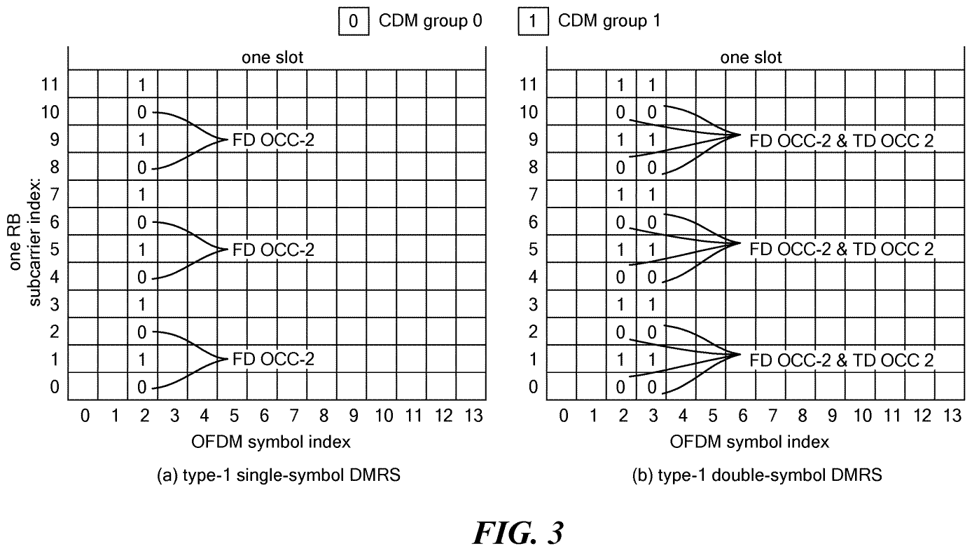

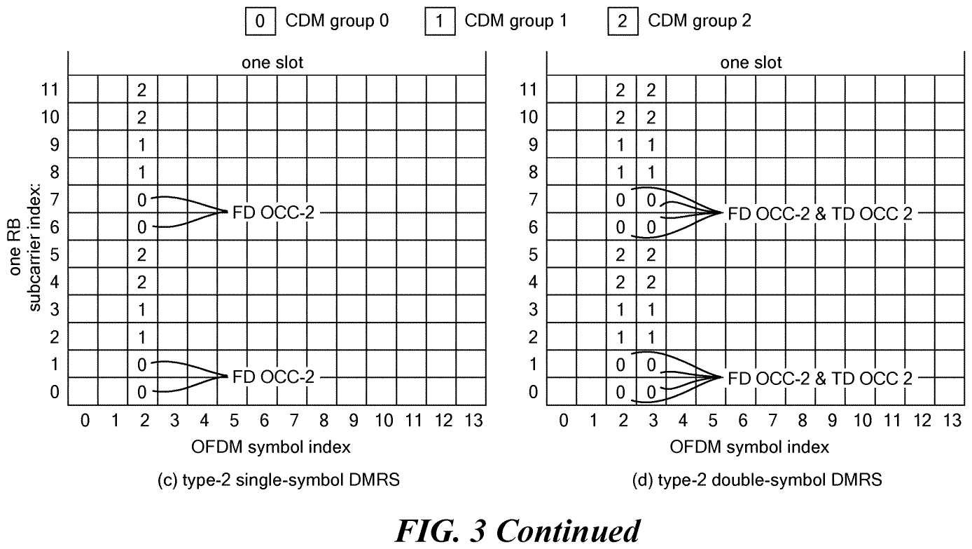

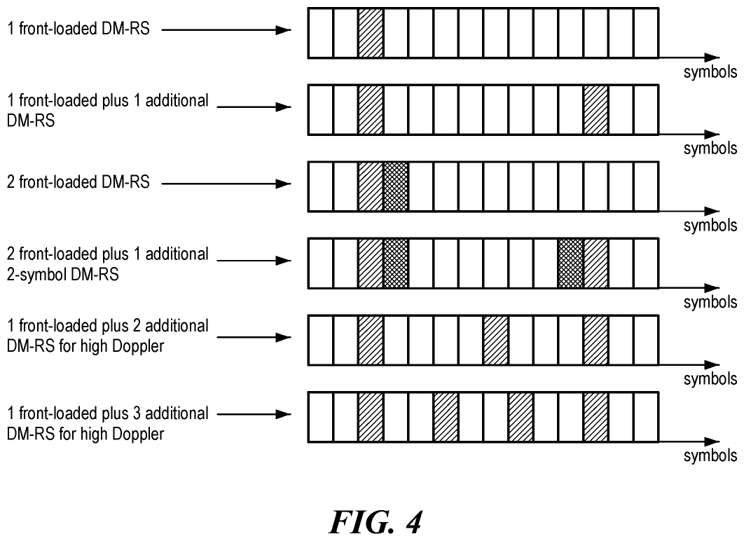

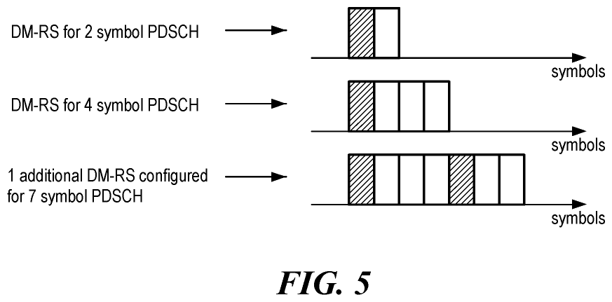

### DETAILED DESCRIPTION

Before describing in detail example embodiments, it is noted that the embodiments reside primarily in combinations of apparatus components and processing steps related to demodulation reference signal (DMRS) co-scheduling assumptions. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

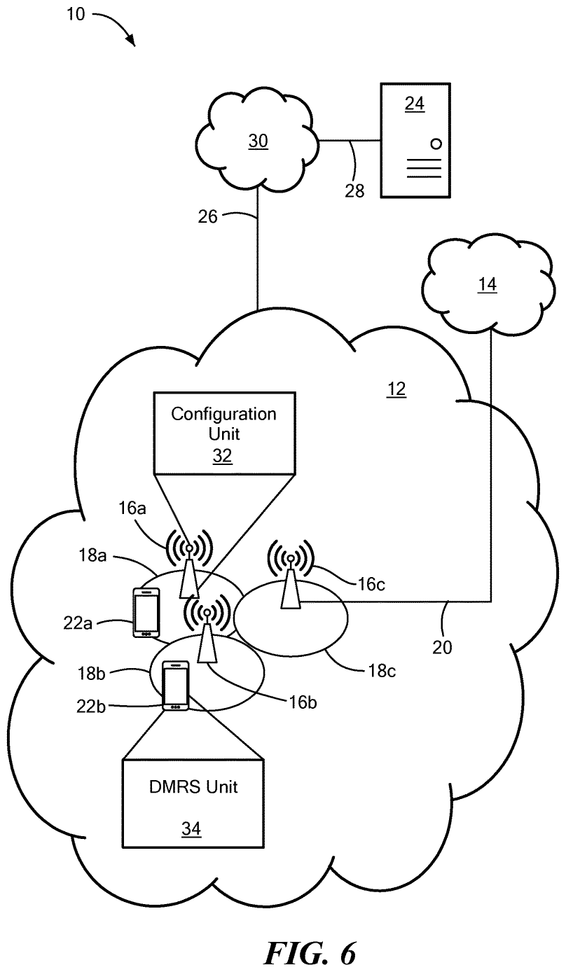

Some embodiments provide demodulation reference signal (DMRS) co-scheduling assumptions. Returning now to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which may be configured to configure co-scheduling assumptions for the WD. The configuration unit 32 may be configured to configure the WD to assume that other co-scheduled WDs are scheduled with demodulation reference signal (DMRS) ports that are sub-length orthogonal to the indicated DMRS ports. A wireless device 22 is configured to include a DMRS unit 34 which may be configured to configure co-scheduling assumptions based on an indication from the network node. The DMRS unit 34 may be configured to, when only frequency domain orthogonal cover code, FD-OCC, vectors of a sub-length orthogonal subset of FD-OCC vectors are used for demodulation reference signal, DMRS, ports by at least one co-scheduled WD, then use a sub-length orthogonality property of an FD-OCC to separate DMRS ports.

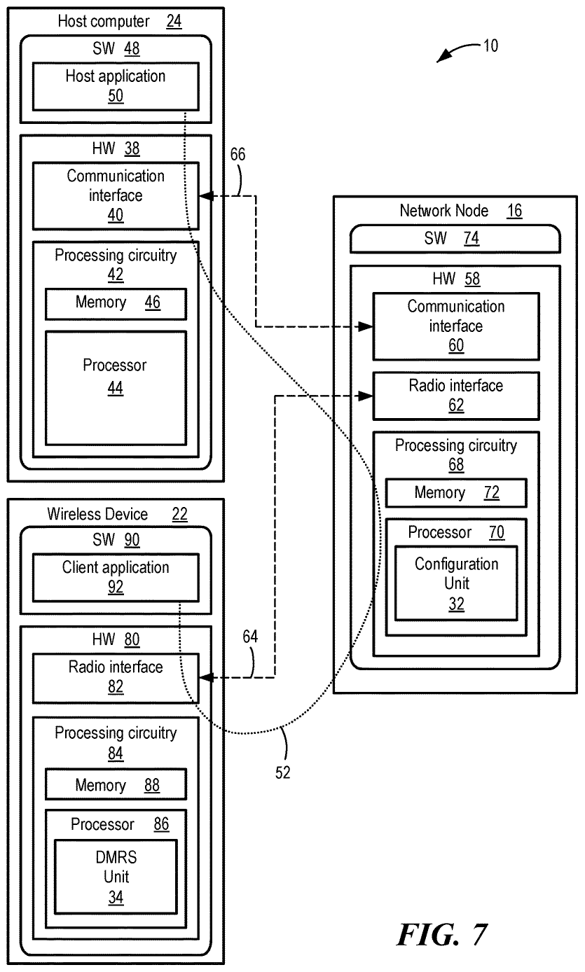

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure co-scheduling assumptions for the WD. The configuration unit 32 may be configured to configure the WD 22 to assume that other co-scheduled WDs 22 are scheduled with demodulation reference signal (DMRS) ports that are sub-length orthogonal to the indicated DMRS ports

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a co-scheduling assumption unit 34 which is configured to configure co-scheduling assumptions based on an indication from the network node. The DMRS unit 34 may be configured to, when only frequency domain orthogonal cover code, FD-OCC, vectors of a sub-length orthogonal subset of FD-OCC vectors are used for demodulation reference signal, DMRS, ports by at least one co-scheduled WD 22, then use a sub-length orthogonality property of an FD-OCC to separate DMRS ports.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and DMRS unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

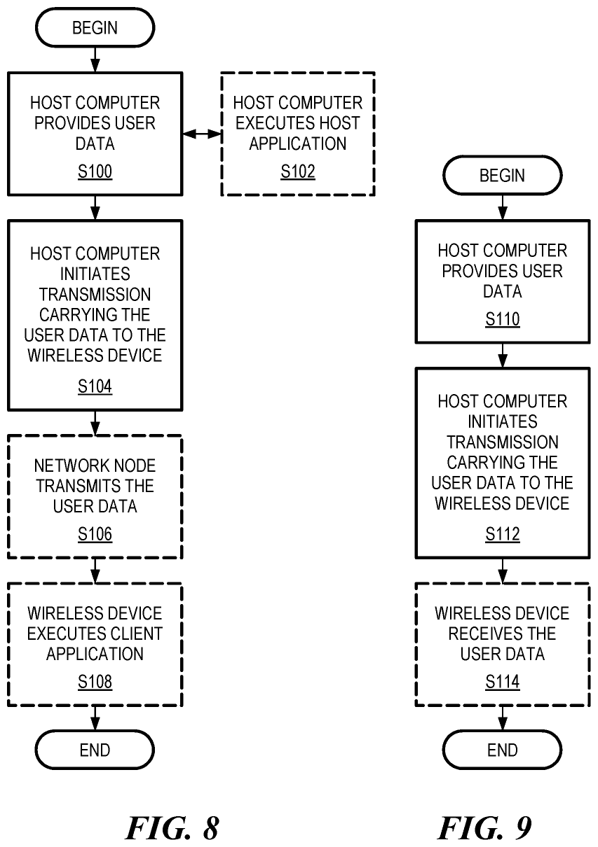

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

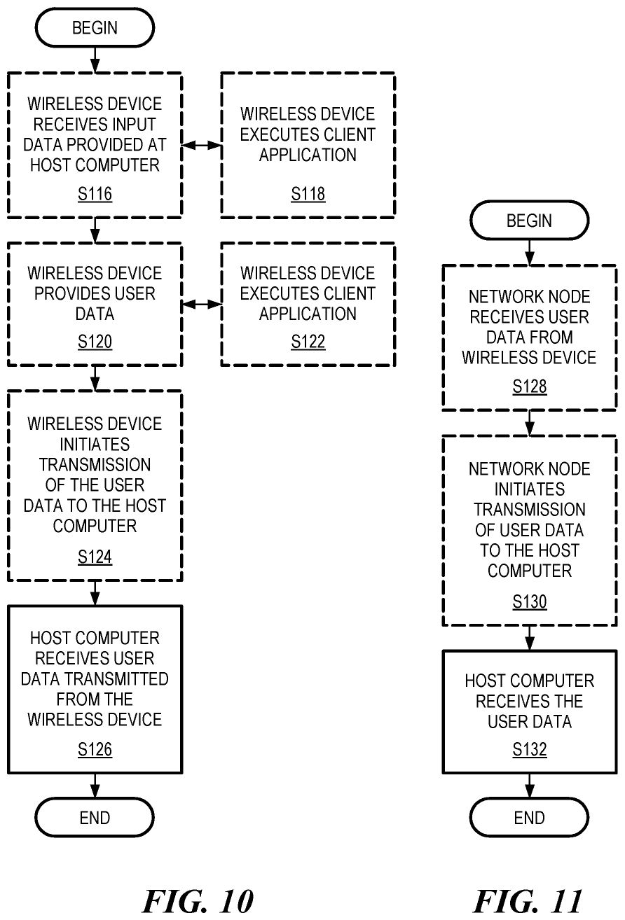

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114). FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

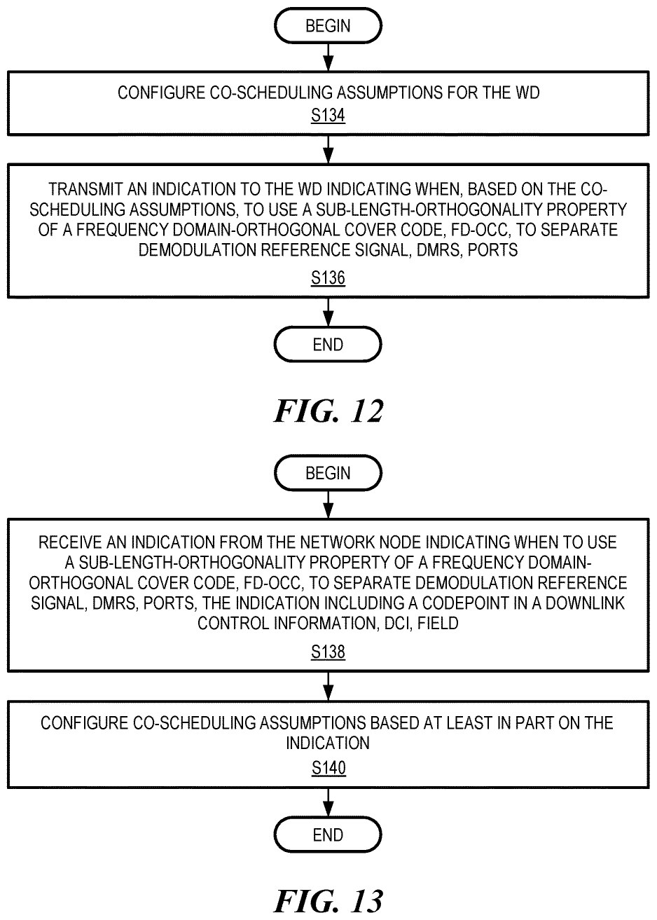

FIG. 12 is a flowchart of an example process in a network node 16 for demodulation reference signal (DMRS) co-scheduling assumptions. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure co-scheduling assumptions for the WD 22 (Block S134). The process also includes transmitting an indication to the WD 22 indicating when, based on the co-scheduling assumptions, to use a sub-length-orthogonality property of a frequency domain-orthogonal cover code, FD-OCC, to separate demodulation reference signal, DMRS, ports (Block S136).

In some embodiments, the indication further indicates a set of at least one codepoint indicating DMRS ports can be separated using sub-length orthogonal FD-OCC. In some embodiments, the indication further indicates when the WD 22 is to assume that any DMRS port used for co-scheduling are sub-length orthogonal to ports used by the WD 22. In some embodiments, the indication further indicates when the WD 22 is to assume that any DMRS port used for co-scheduling uses one of a different code division multiplex, CDM, group and a different time domain orthogonal cover code (TD-OCC) vector than a port used by the WD 22. In some embodiments, the indication further indicates when the WD 22 is to assume that any DMRS port used for co-scheduling is sub-length orthogonal to at least one port indicated by a codepoint. In some embodiments, the indication further indicates when the WD 22 is to assume that any DMRS port used for co-scheduling uses one of a code division multiplex, CDM, group and a time domain orthogonal cover code (TD-OCC) vector that is different than a port indicated by a codepoint.

FIG. 13 is a flowchart of an example process in a wireless device 22 according to some embodiments of the present disclosure. One or more blocks described herein may be performed by one or more elements of wireless device 22 such as by one or more of processing circuitry 84 (including the DMRS unit 34), processor 86, radio interface 82 and/or communication interface 60. Wireless device 22 such as via processing circuitry 84 and/or processor 86 and/or radio interface 82 is configured to receive an indication from the network node indicating when to use a sub-length-orthogonality property of a frequency domain-orthogonal cover code, FD-OCC, to separate demodulation reference signal, DMRS, ports, the indication including a codepoint in a downlink control information, DCI, field (Block S138). The process also includes configuring co-scheduling assumptions based at least in part on the indication (Block S140).

In some embodiments, a co-scheduling assumption includes an assumption that no port based on code division multiplex, CDM, groups corresponding to antenna ports indicated by the codepoint is used for co-scheduled WDs 22. In some embodiments, a co-scheduling assumption includes an assumption that all ports based on code division multiplex, CDM, groups corresponding to antenna ports indicated by the codepoint used for a co-scheduled WD 22 are length-2 FD-OCC orthogonal to ports indicated by the codepoint. In some embodiments, a co-scheduling assumption includes an assumption that all ports based on code division multiplex, CDM, groups corresponding to antenna ports indicated by the codepoint used for a co-scheduled WD 22 are length-3 FD-OCC orthogonal to ports indicated by the codepoint. In some embodiments, the indication further indicates a first set of DMRS ports belonging to a first code division multiplex, CDM, group and a second set of DMRS ports belonging to a second CDM group.

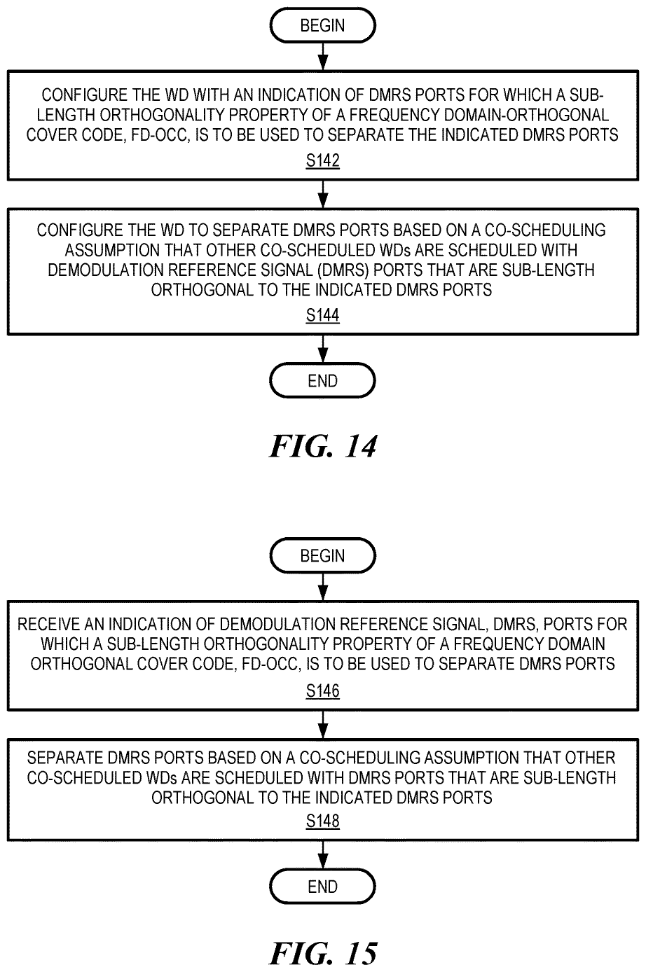

FIG. 14 is a flowchart of an example process in a network node 16 for demodulation reference signal (DMRS) co-scheduling assumptions. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD 22 with an indication of DMRS ports for which an orthogonality property of a frequency domain-orthogonal cover code, FD-OCC, can be used to separate the indicated DMRS ports (Block S142). The process also includes configuring the WD 22 to separate DMRS ports based on a co-scheduling assumption that other co-scheduled WDs 22 are scheduled with demodulation reference signal (DMRS) ports that are sub-length orthogonal to the indicated DMRS ports (Block S144).

According to this aspect, in some embodiments, the indication indicates a length of sub-length orthogonality. In some embodiments, the indication indicates a set of at least one codepoint indicating DMRS ports to be separated using sub-length orthogonal FD-OCC. In some embodiments, the indication indicates when the WD 22 is to assume that a DMRS port used for co-scheduling is sub-length orthogonal to DMRS ports used by the WD 22. In some embodiments, the indication indicates when the WD 22 is to assume that a DMRS port used for co-scheduling uses one of a different code division multiplex, CDM, group and a different time domain orthogonal cover code (TD-OCC) vector than a port and CDM group used by the WD 22. In some embodiments, the indication indicates when the WD 22 is to assume that a DMRS port used for co-scheduling is sub-length orthogonal to at least one port indicated by a codepoint. In some embodiments, the method includes transmitting an indication of at least one other co-scheduled WD 22.

FIG. 15 is a flowchart of an example process in a wireless device 22 according to some embodiments of the present disclosure. One or more blocks described herein may be performed by one or more elements of wireless device 22 such as by one or more of processing circuitry 84 (including the co-scheduling assumption unit 34), processor 86, radio interface 82 and/or communication interface 60. Wireless device 22 such as via processing circuitry 84 and/or processor 86 and/or radio interface 82 is configured to receive an indication of demodulation reference signal, DMRS, ports for which a sub-length orthogonality property of a frequency domain orthogonal cover code, FD-OCC, can be used to separate DMRS ports (Block S138). The process includes separating DMRS ports based on a co-scheduling assumption that other co-scheduled WDs 22 are scheduled with DMRS ports that are sub-length orthogonal to the indicated DMRS ports (Block S140).

According to this aspect, in some embodiments, the method includes assuming that a first DMRS port uses a different code division multiplex, CDM, group than a DMRS port used by a co-scheduled WD 22 indicated by the network node 16. In some embodiments, the method includes receiving an indication of additional co-scheduling assumptions can be used by the WD 22 to separate the DMRS ports. In some embodiments, an additional co-scheduling assumption includes an assumption that all ports based at least in part on CDM groups corresponding to antenna ports indicated by the codepoint are used for co-scheduled WDs 22. In some embodiments, an additional co-scheduling assumption includes an assumption that all ports based at least in part on CDM groups corresponding to antenna ports indicated by the codepoint are length-2 FD-OCC orthogonal to ports indicated by the codepoint. In some embodiments, an additional co-scheduling assumption includes an assumption that all ports based at least in part on CDM groups corresponding to antenna ports indicated by the codepoint used for a co-scheduled WD 22 are length-3 FD-OCC orthogonal to ports indicated by the codepoint. In some embodiments, the method incudes receiving an indication of a first subset of DMRS ports belonging to a first code division multiplex, CDM, group and a subset of DMRS ports belonging to a second CDM group. In some embodiments, using the sub-length orthogonality property includes calculating channel estimates based at least in part on applying the FD-OCC over a sub-length of sub-carriers. In some embodiments, the method includes using sub-length 2 FD-OCC orthogonality to separate the DMRS ports for channel estimation based at least in part on whether a single or double frontloaded DMRS has been configured. In some embodiments, the method includes using sub-length 2 FD-OCC orthogonality to separate the DMRS ports for channel estimation based at least in part on whether a first FD-OCC vector and a first code division multiplex, CDM, group is used for a first DMRS port used for a first layer. In some embodiments, the method includes using sub-length 2 FD-OCC orthogonality to separate the DMRS ports for channel estimation based at least in part on whether a second DMRS port for a second layer uses a second CDM group or uses a second FD-OCC vector that is sub-length 2 orthogonal to the first FD-OCC vector. In some embodiments, when a double frontload DMRS has been configured, the WD 22 is configured to use sub-length 2 FD-OCC orthogonality to separate the DMRS ports based at least in part on whether a time division (TD)-OCC vector is used for the first DMRS port. Having described the general process flow of arrangements of the disclosure and having provided examples of hardware and software arrangements for implementing the processes and functions of the disclosure, the sections below provide details and examples of arrangements for demodulation reference signal (DMRS) co-scheduling assumptions.

### Sub-Length Orthogonal FD-OCC

In 3GPP Rel-18, it is expected that a larger number of DMRS ports will be supported than in earlier releases and that this will be accomplished through the use of length-4 or length-6 FD-OCC to separate the DMRS ports. In earlier releases length-2 FD-OCC was used.

One possibility that has been proposed is to use length-4 or length-6 FD-OCC that have sub-length-orthogonality properties. Table 3 shows three examples of such sub-length orthogonal FD-OCC codes.

The sub-length orthogonality property is also sometimes referred to as super-orthogonality. Here, without loss of generality, the term sub-length orthogonality is used.

TABLE 1
Examples of FD-OCC codes of length 4 and length 6 with sub length
orthogonality properties.

| FD- | Length 4 | Length 4 | |
|---|---|---|---|
| OCC | FD-OCC | FD-OCC | |
| Vector | real | cyclic | Length 6 FD-OCC cyclic |
| W₁ | [+1 +1 +1 +1] | [+1 +1 +1 +1] | $[ {( {e}^{j \frac{2 π}{6}} )}^{0} {( {e}^{j \frac{2 π}{6}} )}^{1} {( {e}^{j \frac{2 π}{6}} )}^{2} {( {e}^{j \frac{2 π}{6}} )}^{3} {( {e}^{j \frac{2 π}{6}} )}^{4} {( {e}^{j \frac{2 π}{6}} )}^{5} ]$ |
| W₂ | [+1 −1 +1 −1] | [+1 −1 +1 −1] | $[ {( {e}^{j \frac{2 π}{6}} )}^{0} {( {e}^{j \frac{2 π}{6}} )}^{4} {( {e}^{j \frac{2 π}{6}} )}^{8} {( {e}^{j \frac{2 π}{6}} )}^{12} {( {e}^{j \frac{2 π}{6}} )}^{16} {( {e}^{j \frac{2 π}{6}} )}^{20} ]$ |
| W₃ | [+1 −1 −1 +1] | [+1 +j −1 −j] | $[ {( {e}^{j \frac{2 π}{6}} )}^{0} {( {e}^{j \frac{2 π}{6}} )}^{2} {( {e}^{j \frac{2 π}{6}} )}^{4} {( {e}^{j \frac{2 π}{6}} )}^{6} {( {e}^{j \frac{2 π}{6}} )}^{8} {( {e}^{j \frac{2 π}{6}} )}^{10} ]$ |
| W₄ | [+1 +1 −1 −1] | [+1 −j −1 +j] | $[ {( {e}^{j \frac{2 π}{6}} )}^{0} {( {e}^{j \frac{2 π}{6}} )}^{5} {( {e}^{j \frac{2 π}{6}} )}^{10} {( {e}^{j \frac{2 π}{6}} )}^{15} {( {e}^{j \frac{2 π}{6}} )}^{20} {( {e}^{j \frac{2 π}{6}} )}^{25} ]$ |
| W₅ | | | $[ {( {e}^{j \frac{2 π}{6}} )}^{0} {( {e}^{j \frac{2 π}{6}} )}^{0} {( {e}^{j \frac{2 π}{6}} )}^{0} {( {e}^{j \frac{2 π}{6}} )}^{0} {( {e}^{j \frac{2 π}{6}} )}^{0} {( {e}^{j \frac{2 π}{6}} )}^{0} ]$ |
| W₆ | | | $[ {( {e}^{j \frac{2 π}{6}} )}^{0} {( {e}^{j \frac{2 π}{6}} )}^{3} {( {e}^{j \frac{2 π}{6}} )}^{6} {( {e}^{j \frac{2 π}{6}} )}^{9} {( {e}^{j \frac{2 π}{6}} )}^{12} {( {e}^{j \frac{2 π}{6}} )}^{15} ]$ |

These OCC vectors obviously fulfill the normal orthonormality property:

$${w}_{k}^{∘} {w}_{l} = \frac{1}{M} {\sum }_{m = 1}^{M} {w}_{k , m} \cdot {w}_{l , m}^{*} = {δ}_{k , l}$$

where w_{k,m} is element m of FD-OCC vector k, w_{l,m} is element m of FD-OCC vector l, and M is the length of the FD-OCC vectors (i.e., M is equal to 4 or 6 in the examples) and * denotes complex conjugation.

In addition, the FD-OCC vector subsets {w₁, w₂}, {w₃, w₄}, and for the length 6 codes also {w₅, w₆} are each sub-length orthogonal over any two consecutive vector elements, i.e.:

$${\sum }_{m ∈ \{ n , ( n mod M ) + 1 \}} {w}_{1 , m} \cdot {w}_{2 , m}^{*} = 0$$

$${\sum }_{m ∈ \{ n , ( n mod M ) + 1 \}} {w}_{3 , m} \cdot {w}_{4 , m}^{*} = 0$$

$${\sum }_{m ∈ \{ n , ( n mod M ) + 1 \}} {w}_{5 , m} \cdot {w}_{6 , m}^{*} = 0$$

for any n∈{1, 2, . . . , M}. Note the first and the last vector element as consecutive, i.e., when viewing the vector elements as being cyclic.

More generally, FD-OCC vectors may have sub-length orthogonality properties for general integer sub-lengths s (i.e., also other than 2). One would then have a number of FD-OCC vector subsets with vectors that within a subset are mutually sub-length orthogonal over any sub-length s of consecutive vector elements, i.e.:

$${\sum }_{m = n}^{n + s - 1} {w}_{a , m} \cdot {w}_{b , m}^{*} = 0 ∀ {w}_{a} ∈ ℳ , {w}_{b} ∈ ℳ$$

for any n∈{1, 2, . . . , M} and where [symbol] is any of the length s sub-length orthogonal subsets of FD-OCC vectors and where the vectors are extended cyclically as:

$${w}_{k , m} = {w}_{k , m - M}$$

for m>M in order to simplify the formula (i.e., avoiding the use of the modulo operation).

In fact, the Length-6 FD-OCC vectors in Table 3 do not only have the sub-length 2 orthogonality property described above. It also has sub-length 3 orthogonality for the subsets {w₁, w₄, w₆}, and {w₂, w₃, w₅}.

### Sub-Length Orthogonal DMRS Port Decoding

In some embodiments, if only FD-OCC vectors within one sub-length orthogonal subset of FD-OCC vectors are used for DMRS ports by any of a number of co-scheduled WDs 22, then the WD 22 uses the sub-length orthogonality property to separate DMRS ports.

In some embodiments, the use of the sub-length orthogonality property is performed by calculating raw channel estimates by applying the FD-OCC code over sub-length nr of subcarriers. Channel estimates for all resource elements utilized by the PDSCH may then be calculated through filtering and interpolation/extrapolation of the raw channel estimates.

In some embodiments, separation of ports using the sub-length orthogonality property and estimating the channel for all resource elements utilized by the PDSCH is performed as one MMSE optimization step.

The use of sub-length orthogonality gives reduced sensitivity to delay spread and thus improves channel estimation and throughput.

In NR, FD-OCC is combined with FDM, i.e., the use of different CDM groups to separate DMRS ports. If different CDM groups are used to separate two different ports then it obviously doesn't matter which FD-OCC code is used.

If double frontloaded DMRS symbols are used, the TD-OCC may also be used to separate ports. If two ports may be separated through TD-OCC, then again it doesn't matter what FD-OCC code was used, in some embodiments.

The method may be employed for the case of combining FD-OCC with other port separation methods like FDM and TD-OCC. The following are examples.

In some embodiments, if:
single frontloaded DMRS has been configured; and
FD-OCC vector k, and CDM group g is used for the DMRS port used for a certain layer for a certain WD 22; and
Any other port utilized for any other layer of the same WD 22 or a different co-scheduled WD 22 is either utilizing a different CDM group (i.e., other than g), or it uses an FD-OCC vector which is sublength-2 orthogonal to the FD-OCC vector k:
   then the WD 22 utilizes sub-length-2 FD-OCC orthogonality to separate the DMRS ports for channel estimation.

In some embodiments, if:
Double frontloaded DMRS has been configured; and
FD-OCC vector k, TD-OCC vector l, and CDM group g is used for the DMRS port used for a certain layer for a certain WD 22; and
Any other port utilized for any other layer of the same WD 22 or a different co-scheduled WD 22 is either utilizing a different CDM group (i.e., other than g), or it utilizes a different TD-OCC vector, or it uses an FD-OCC vector which is sublength-2 orthogonal to the FD-OCC vector k:
   then the WD 22 utilizes sublength-2 FD-OCC orthogonality to separate the ports

### Indication of Co-Scheduling Assumptions for Sub-Length Orthogonality

In some embodiments, the DCI may explicitly indicate whether the WD 22 may use sub-length orthogonal FD-OCC to separate a certain port.

In some embodiments, the WD 22 is preconfigured to know that with one or more codepoints in the ‘antenna ports’ field in the DCI, the WD 22 may use sub-length orthogonal FD-OCC to separate the ports indicated by the codepoints value.

In some embodiments, the DCI may explicitly indicate whether the WD 22 may assume that any port used for a co-scheduled WD 22 may be assumed to be either sub-length orthogonal to the port or ports used by the WD 22 or utilizes a different CDM group or a different TD-OCC vector than the port used by the WD 22.

In some embodiments it is specified (i.e., the WD 22 is preconfigured to know) that for one or more codepoints in the ‘antenna ports’ field in the DCI the WD 22 may assume that any port used for a co-scheduled WD 22 is either sub-length orthogonal to the port or ports indicated by the codepoint or it utilizes a different CDM group or a different TD-OCC vector than the port or ports indicated by the codepoint.

The above-described methods may be captured in specifications, for example, through the use of a table of the type of Table 7.3.1.2.2-2 in 3GPP TS 38.212, capturing for each codepoint in the ‘antenna ports’ field in the DCI (as given by the first column in the table):
Number of DMRS CDM group(s) without data;
DMRS port(s); and/or
Number of front-load symbols.
   and specifying one or more codepoints in the ‘antenna ports’ field in the DCI for which the WD 22 may make the assumptions described above.

Note that the codepoint in the ‘antenna ports’ field in the DCI is given by the value in the first column of the table as in the table 7.3.1.2.2-2 in 3GPP TS 38.212 V17.3.0. This value (or codepoint) is what is transmitted in the antenna ports field in the DCI.

In some embodiments, the table may contain two lines that are identical except for the codepoint value in the first column of the table (i.e., two codepoint values correspond to 1) indicating the same Number of DMRS CDM group(s) without data and 2) indicating the same DMRS port(s) and 3) indicating the same Number of front-load symbols). However, it is only specified that the WD 22 may make the assumptions described above for one of the two codepoint values.

Thus, if the network node 16 is not co-scheduling any other WD 22 using a port which isn't sub-length-2 orthogonal to the ports indicated by the two DCI values, then the network may use the value for which the WD 22 is allowed to make the co-scheduling assumption.

If, on the other hand, the network node 16 is co-scheduling another WD 22 using a port which is sub-length-2 orthogonal to the ports indicated by the two DCI values, then the network node 16 may use the value for which the WD 22 is not allowed to make the co-scheduling assumption.

Thus, the network node 16 may indicate to the WD 22 what DMRS port separation method to use.

TABLE 7.3.1.2.2-2
Antenna port(s) (1000 + DMRS port), dmrs-Type = 1,
maxLength = 2 (from 3GPP TS 38.212 V17.3.0)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In some embodiments, if the WD 22 receives an indication of two or more ports corresponding to any of the following:
two antenna ports corresponding to length-4 FD-OCC or length-6 FD-OCC subsets {w₁, w₂};
two antenna ports corresponding to length-4 FD-OCC or length-6 FD-OCC subsets {w₃, w₄};
two antenna ports corresponding to length-6 FD-OCC subsets {w₅, w₆};
two or more antenna ports corresponding to length-6 FD-OCC subsets {w₁, w₄, w₆}; and/or
two or more antenna ports corresponding to length-6 FD-OCC subsets {w₂, w₃, w₅};
   and if the WD 22 is indicated that no other WDs 22 are scheduled in the same CDM group(s) containing the indicated two or more antenna ports, then the WD 22 may assume sub-length orthogonal FD-OCC to separate the indicated two or more antenna ports.

In some embodiments, each codepoint in the Antenna ports field in DCI may indicate if any other WD 22 is co-scheduled by a binary indicator (e.g., via a dedicated column in the antenna ports table). In some embodiments, if the antenna ports indicated to a WD 22 correspond to more than one CDM group, then for each CDM group a binary indicator is used to indicate if any other WD 22 is co-scheduled in the respective CDM group. This information may be used by the WD 22 to decide if it may assume sub-length orthogonal FD-OCC to separate DMRS ports for channel estimation.

In some embodiments, each codepoint in the antenna ports field in DCI may indicate if the WD 22 may assume sub-length orthogonal FD-OCC to separate the indicated two or more antenna ports (e.g., indicated via a dedicated column in the antenna ports table) using a binary indicator. In some embodiments, a binary indicator is indicated for each CDM group corresponding to the antenna ports indicated by the codepoint in the Antenna ports field in DCI.

In some embodiments, each codepoint in the antenna ports field in DCI may indicate the length of orthogonal FD-OCC the WD 22 should use to separate the antenna ports (e.g., indicated via a dedicated column in the antenna ports table). As an example, for length-6 FD-OCC, four indicator values may be used as follows:
Length 1: No FD-OCC decoding is needed;
Length 2: Sublength-2 FD-OCC decoding is needed;
Length 3: Sublength-3 FD-OCC decoding is needed; and
Length 6: Full length-6 FD-OCC decoding is needed.

In some embodiments, the length of orthogonal FD-OCC the WD 22 should use may be indicated separately for each CDM group corresponding to the antenna ports indicated by the codepoint in the antenna ports field in DCI.

In some embodiments, for each codepoint in the Antenna ports field, an indication of what co-scheduling assumptions the WD 22 may assume is given (e.g., via a dedicated column in the antenna ports table). As an example for length-6 FD-OCC four indicator values may be used:
Value 1: The WD 22 may assume that no port based on the CDM groups corresponding to the antenna ports indicated by the codepoint in the antenna ports field in DCI is utilized for any co-scheduled WD 22;
Value 2: The WD 22 may assume that all ports based on the CDM groups corresponding to the antenna ports indicated by the codepoint in the antenna ports field in DCI utilized for any co-scheduled WD 22 are length-2 FD-OCC orthogonal to the ports indicated by the codepoint in the antenna ports field in DCI;
Value 3: The WD 22 may assume that all ports based on the CDM groups corresponding to the antenna ports indicated by the codepoint in the antenna ports field in DCI utilized for any co-scheduled WD 22 are length-3 FD-OCC orthogonal to the ports indicated by the codepoint in the Antenna ports field in DCI; and
Value 4: The WD 22 may not make any scheduling assumption regarding co-scheduled WDs 22.

In some embodiments, co-scheduling assumptions the WD may make may be indicated separately for each CDM group corresponding to the antenna ports indicated by the codepoint in the Antenna ports field in DCI.

### Sub-Length Orthogonal DMRS Port Decoding and Indication for 6G

As described above, in 3GPP NR Rel-18, the legacy (e.g., 3GPP Rel-15) DMRS designs will be extended to support more DMRS ports to better support multi-user (MU)-MIMO with many simultaneously scheduled WDs 22. In 6G (and beyond), it may be possible that the DMRS is designed directly to support an even large number of co-scheduled WD 22 for MU-MIMO. For example, the DMRS design may be based on an FD-OCC code length that exceeds 4 or 6. For example, the FD-OCC length may be 8, 10 or 12 (or even higher), in order to enable enough DMRS capacity for the future needs of MU-MIMO. However, as described above, when using FD-OCC codes on DMRS, it is useful during DMRS decoding/channel estimation for the WD 22 to know if there are any other co-scheduled WDs 22 allocated to the same CDM group (in 6G, a term other than CDM group may be used to refer to the same thing. Herein, with a CDM group in this case, the DMRS Ports may be allocated to the same sub-carriers and the other DMRS ports are sub-length orthogonal to the DMRS ports used for that WD 22.

In cases where the FD-OCC length is equal to 8, there may be different lengths of sub-length orthogonality. For example, two of the 8 DMRS ports separated with the length 8 FD-OCC code, might be sub-length orthogonal to each other with length 2. However, it is also possible that the two DMRS ports are sub-length orthogonal to each other with length 4. In this case it would be useful for the WD 22 to know which length the sub-length orthogonality between the DMRS ports has, since the WD 22 may perform a better DMRS channel estimate/decoding in case it knows that the other DMRS port is sub-length orthogonal with length 2 instead of sub-length orthogonal with length 4. In a similar way, a FD-OCC code with length 12 may be sub-length orthogonal with length 3 and with length 6.

Hence, in some embodiments, a new field in DCI may be used to indicate if a WD 22 may assume that other co-scheduled WDs 22 are scheduled with DMRS ports (in the same CDM group, i.e., same frequency allocation) that are sub-length orthogonal to the indicated DMRS ports, and if so, what length the sub-length orthogonality has. In one example, a bitfield is included in DCI, where one codepoint of the bitfield is used to indicate that the co-scheduled DMRS(s) are scheduled in the same CDM group and where the co-scheduled DMRS ports that are sub-length orthogonal with length 2 to the indicated DMRS Ports, and a second codepoint is used to indicate that the co-scheduled DMRS are scheduled in the same CDM group and where the co-scheduled DMRS ports that are sub-length orthogonal with length 4 to the indicated DMRS Ports.

In some embodiments, the information about whether a WD 22 may assume that other co-scheduled WDs 22 are scheduled with DMRS ports that are sub-length orthogonal to the indicated DMRS ports, and if so, what length the sub-length orthogonality has, is included in a pre-configured antenna port table (for example similar to Table 7.3.1.2.2-2 in 3GPP TS 38.212 V17.3.0). In some embodiments, it is pre-defined that certain entries in the antenna port table are used to indicate that co-scheduled WDs 22 are scheduled with DMRS ports that are sub-length orthogonal with length 2 to the indicated DMRS port. It may also be pre-defined that other certain entries in the antenna port table are used to indicate that co-scheduled WDs 22 are scheduled with DMRS ports that are sub-length orthogonal with length 4 to the indicated DMRS port. In some embodiments, the network node 16 may configure (e.g., using RRC) which entries of the antenna port table are assumed by the WD 22 to have a certain sub-length orthogonality between indicated DMRS ports and DMRS ports scheduled for other WDs 22 (in the same CDM group).

Note that some embodiments are described for an example where the FD-OCC length is 8, and hence, the sub-length orthogonality lengths are 2 and 4. However, any other numbers of FD-OCC lengths are also supported, e.g., an FD-OCC code with length 12 may be used to indicate sub-length orthogonality with length 3 or sub-length orthogonality with length 6.

In some embodiments, a WD 22 may be indicated with two or more DMRS ports, where a first subset of the indicated DMRS ports belongs to a first CDM group, and a second subset of the indicated DMRS ports belongs to a second CDM group. In some embodiments, the DCI may indicate if a WD 22 may assume that other co-scheduled WDs 22 are scheduled with DMRS ports that are sub-length orthogonal to the indicated DMRS ports for each CDM group separately. For example, the DCI may indicate that a first subset of the indicated DMRS ports belonging to a first CDM group are co-scheduled with DMRS ports (for other WDs 22) belonging to the first CDM group and that are sub-length orthogonal (and potentially which length the sub-length orthogonality has) to the indicated DMRS ports of the first CDM group. The same DCI may indicate that a second subset of the indicated DMRS ports belonging to a second CDM group are co-scheduled with DMRS ports (for other WDs 22) belonging to the second CDM group and that are sub-length orthogonal (and potentially with length the sub-length orthogonality has) to the indicated DMRS ports of the second CDM group.

In some embodiments, the DCI may indicate exactly which DMRS ports co-schedule WDs 22 are using. In this way, the scheduled WD 22 will get all the information about an interfering DMRS port, which may be used both to maximize the performance of the channel estimation/decoding of the indicated DMRS ports, and to determine the interference situation for future scheduled PDSCH MU-MIMO.

In some embodiments, a field in DCI is used to indicate all the DMRS ports that are scheduled for co-scheduled WDs 22.

In some embodiments, a field in DCI may be used to indicate all the DMRS ports that are scheduled for co-scheduled WDs 22 that are within the same CDM group(s) as the indicate DMRS ports.

Some embodiments described herein may apply to 5G/NR and some embodiments described herein may apply to 6G. Some embodiments described herein may apply to 5G and 6G.

Some embodiments may include one or more of the following:

Embodiment A1. A network node configured to communicate with a wireless device (WD), the network node configured to, and/or comprising a radio interface and/or comprising processing circuitry configured to:
configure co-scheduling assumptions for the WD; and
transmit an indication to the WD indicating when, based on the co-scheduling assumptions, to use a sub-length-orthogonality property of a frequency domain-orthogonal cover code, FD-OCC, to separate demodulation reference signal, DMRS, ports.

Embodiment A2. The network node of Embodiment A1, wherein the indication further indicates a set of at least one codepoint indicating DMRS ports to be separated using sub-length orthogonal FD-OCC.

Embodiment A3. The network node of any of Embodiments A1 and A2, wherein the indication further indicates when the WD is to assume that any DMRS port used for co-scheduling are sub-length orthogonal to ports used by the WD.

Embodiment A4. The network node of any of Embodiments A1-A3, wherein the indication further indicates when the WD is to assume that any DMRS port used for co-scheduling uses one of a different code division multiplex, CDM, group and a different time domain orthogonal cover code (TD-OCC) vector than a port used by the WD.

Embodiment A5. The network node of any of Embodiments A1-A4, wherein the indication further indicates when the WD is to assume that any DMRS port used for co-scheduling is sub-length orthogonal to at least one port indicated by a codepoint.

Embodiment A6. The network node of any of Embodiments A1-A5, wherein the indication further indicates when the WD is to assume that any DMRS port used for co-scheduling uses one of a code division multiplex, CDM, group and a time domain orthogonal cover code (TD-OCC) vector that is different than a port indicated by a codepoint.

Embodiment B1. A method implemented in a network node configured to communicate with a WD, the method comprising:
configuring co-scheduling assumptions for the WD; and
transmitting an indication to the WD indicating when, based on the co-scheduling assumptions, to use a sub-length-orthogonality property of a frequency domain-orthogonal cover code, FD-OCC, to separate demodulation reference signal, DMRS, ports.

Embodiment B2. The method of Embodiment B1, wherein the indication further indicates a set of at least one codepoint indicating DMRS ports to be separated using sub-length orthogonal FD-OCC.

Embodiment B3. The method of any of Embodiments B1 and B2, wherein the indication further indicates when the WD is to assume that any DMRS port used for co-scheduling are sub-length orthogonal to ports used by the WD.

Embodiment B4. The method of any of Embodiments B1-B3, wherein the indication further indicates when the WD is to assume that any DMRS port used for co-scheduling uses one of a different code division multiplex, CDM, group and a different time domain orthogonal cover code (TD-OCC) vector than a port used by the WD.

Embodiment B5. The method of any of Embodiments B1-B4, wherein the indication further indicates when the WD is to assume that any DMRS port used for co-scheduling is sub-length orthogonal to at least one port indicated by a codepoint.

Embodiment B6. The method of any of Embodiments B1-B5, wherein the indication further indicates when the WD is to assume that any DMRS port used for co-scheduling uses one of a code division multiplex, CDM, group and a time domain orthogonal cover code (TD-OCC) vector that is different than a port indicated by a codepoint.

Embodiment C1. A wireless device (WD) configured to communicate with a network node, the WD configured to, and/or comprising a radio interface and/or processing circuitry configured to:
receive an indication from the network node indicating when to use a sub-length-orthogonality property of a frequency domain-orthogonal cover code, FD-OCC, to separate demodulation reference signal, DMRS, ports, the indication including a codepoint in a downlink control information, DCI, field; and
configure co-scheduling assumptions based at least in part on the indication.

Embodiment C2. The WD of Embodiment C1, wherein a co-scheduling assumption includes an assumption that no port based on code division multiplex, CDM, groups corresponding to antenna ports indicated by the codepoint is used for co-scheduled WDs

Embodiment C3. The WD of any of Embodiments C1 and C2, wherein a co-scheduling assumption includes an assumption that all ports based on code division multiplex, CDM, groups corresponding to antenna ports indicated by the codepoint used for a co-scheduled WD are length-2 FD-OCC orthogonal to ports indicated by the codepoint.

Embodiments C4. The WD of Embodiments C1-C3, wherein a co-scheduling assumption includes an assumption that all ports based on code division multiplex, CDM, groups corresponding to antenna ports indicated by the codepoint used for a co-scheduled WD are length-3 FD-OCC orthogonal to ports indicated by the codepoint.

Embodiment C5. The WD of Embodiments C1-C4, wherein the indication further indicates a first set of DMRS ports belonging to a first code division multiplex, CDM, group and a second set of DMRS ports belonging to a second CDM group.

Embodiment D1. A method implemented in a wireless device (WD), the method comprising
receiving an indication from the network node indicating when to use a sub-length-orthogonality property of a frequency domain-orthogonal cover code, FD-OCC, to separate demodulation reference signal, DMRS, ports, the indication including a codepoint in a downlink control information, DCI, field; and
configuring co-scheduling assumptions based at least in part on the indication.

Embodiment D2. The method of Embodiment D1, wherein a co-scheduling assumption includes an assumption that no port based on code division multiplex, CDM, groups corresponding to antenna ports indicated by the codepoint is used for co-scheduled WDs

Embodiment D3. The method of any of Embodiments D1 and D2, wherein a co-scheduling assumption includes an assumption that all ports based on code division multiplex, CDM, groups corresponding to antenna ports indicated by the codepoint used for a co-scheduled WD are length-2 FD-OCC orthogonal to ports indicated by the codepoint.

Embodiments D4. The method of Embodiments D1-D3, wherein a co-scheduling assumption includes an assumption that all ports based on code division multiplex, CDM, groups corresponding to antenna ports indicated by the codepoint used for a co-scheduled WD are length-3 FD-OCC orthogonal to ports indicated by the codepoint.

Embodiment D5. The method of Embodiments D1-D4, wherein the indication further indicates a first set of DMRS ports belonging to a first code division multiplex, CDM, group and a second set of DMRS ports belonging to a second CDM group.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-38. (canceled)

39. A wireless device (WD) configured to communicate with a network node and support demodulation reference signal (DMRS) ports with frequency domain orthogonal cover code (FD-OCC) having a length not less than 4, the WD comprising a radio interface for wireless communication, one or more processors and a memory comprising instructions which, when executed by the one or more processors, cause the WD to:
receive a configuration from the network node for DMRS port(s) with a sub-length FD-OCC; and
utilize sub-length orthogonality of the FD-OCC to separate the configured DMRS port(s) from other co-scheduled WD(s) on a same resources.

40. The WD of claim 39, wherein the WD is further configured to:
receive an indication that the other co-scheduled WD(s) are scheduled with DMRS ports that are sub-length orthogonal to the configured DMRS ports;
assume that the other co-scheduled WD(s) are scheduled with DMRS ports that are sub-length orthogonal to the configured DMRS ports; or
receive one or more codepoints indicating at least a part of the configured port(s) being sub-length orthogonal to DMRS port(s) configured for the other co-scheduled WDs.

41. The WD of claim 40, wherein the configuration comprises an indication of a subset of FD-OCC vectors and a code division multiplex (CDM) group used for the configured DMRS port(s) for a certain layer, wherein the WD is configured to utilize a subset of FD-OCC vectors to separate the configured DMRS port(s) from the other co-scheduled WD(s).

42. The WD of claim 40, wherein the sub-length orthogonality is sub-length 2 orthogonality, wherein the WD is configured to utilize the sub-length 2 orthogonality of the FD-OCC to separate the configured DMRS ports for channel estimation.

43. The WD of claim 39, wherein the configuration comprises an indication of a subset of FD-OCC vectors and a code division multiplex (CDM) group used for the configured DMRS port(s) for a certain layer, wherein the WD is configured to utilize a subset of FD-OCC vectors to separate the configured DMRS port(s) from the other co-scheduled WD(s).

44. The WD of claim 39, wherein the sub-length orthogonality is sub-length 2 orthogonality, wherein the WD is configured to utilize the sub-length 2 orthogonality of the FD-OCC to separate the configured DMRS ports for channel estimation.

45. A method in a wireless device (WD) configured to communicate with a network node and support demodulation reference signal (DMRS) ports with frequency domain orthogonal cover code (FD-OCC) having a length not less than 4, the method comprising:
receiving a configuration from the network node for DMRS port(s) with a sub-length FD-OCC; and
utilizing sub-length orthogonality of the FD-OCC to separate the configured DMRS port(s) from other co-scheduled WD(s) on a same resources.

46. The method of claim 45, further comprising:
receiving an indication that the other co-scheduled WD(s) are scheduled with DMRS ports that are sub-length orthogonal to the configured DMRS ports;
assuming that the other co-scheduled WD(s) are scheduled with DMRS ports that are sub-length orthogonal to the configured DMRS ports; or
receiving one or more codepoints indicating at least a part of the configured port(s) being sub-length orthogonal to DMRS port(s) configured for the other co-scheduled WDs.

47. The method of claim 46, wherein the configuration comprises an indication of a subset of FD-OCC vectors and a code division multiplex (CDM) group used for the configured DMRS port(s) for a certain layer, wherein the WD is configured to utilize a subset of FD-OCC vectors to separate the configured DMRS port(s) from the other co-scheduled WD(s).

48. The method of claim 46, wherein the sub-length orthogonality is sub-length 2 orthogonality, wherein the WD utilizing the sub-length orthogonality of the FD-OCC comprises:
utilizing the sub-length 2 orthogonality of the FD-OCC to separate the configured DMRS ports for channel estimation.

49. The method of claim 45, wherein the configuration comprises an indication of a subset of FD-OCC vectors and a code division multiplex (CDM) group used for the configured DMRS port(s) for a certain layer, wherein the WD is configured to utilize a subset of FD-OCC vectors to separate the configured DMRS port(s) from the other co-scheduled WD(s).

50. The method of claim 45, wherein the sub-length orthogonality is sub-length 2 orthogonality, wherein the WD utilizing the sub-length orthogonality of the FD-OCC comprises:
utilizing the sub-length 2 orthogonality of the FD-OCC to separate the configured DMRS ports for channel estimation.

51. The method of claim 50, wherein utilizing the sub-length 2 orthogonality of the FD-OCC to separate the configured DMRS ports is based at least in part on whether a single or double frontloaded DMRS has been configured.

52. The method of claim 51, wherein, when a double frontload DMRS has been configured, the method comprises utilizing the sub-length 2 orthogonality of the FD-OCC, and time division OCC, TD-OCC vector(s) to separate the configured DMRS ports from the other co-scheduled WD(s).

53. A method in a network node configured to communicate with a wireless device (WD) which supports demodulation reference signal (DMRS) ports with frequency domain orthogonal cover code (FD-OCC) having a length not less than 4, the method comprising:
configuring the WD with for DMRS port(s) with a sub-length FD-OCC.

54. The method of claim 53, further comprising:
transmitting an indication to the WD that the other co-scheduled WD(s) are scheduled with DMRS ports that are sub-length orthogonal to the configured DMRS ports; or
transmitting one or more codepoints indicating at least a part of the configured port(s) being sub-length orthogonal to DMRS port(s) configured for the other co-scheduled WDs.

55. The method of claim 54, wherein the configuration comprises an indication of a subset of FD-OCC vectors and a code division multiplex (CDM) group used for the configured DMRS port(s) for a certain layer, which are usable by the WD to separate the configured DMRS port(s) from the other co-scheduled WD(s).

56. The method of claim 54, wherein the sub-length orthogonality is sub-length 2 orthogonality, the method further comprising scheduling the WD and the other WD on a same resource.

57. The method of claim 53, wherein the configuration comprises an indication of a subset of FD-OCC vectors and a code division multiplex (CDM) group used for the configured DMRS port(s) for a certain layer, which are usable by the WD to separate the configured DMRS port(s) from the other co-scheduled WD(s).

58. The method of claim 53, wherein the sub-length orthogonality is sub-length 2 orthogonality, the method further comprising scheduling the WD and the other WD on a same resource.
